(19) United States
(12) Patent Application Publication
(10) Pub. No.: US 2020/0271223 A1
(43) Pub. Date: Aug. 27, 2020

(54) GEAR SELECTION AND PARKING LOCK SYSTEM

(71) Applicant: ZF Friedrichshafen AG, Friedrichshafen (DE)

(72) Inventors: Ludger Rake, Steinfeld (DE); Joachim Spratte, Osnabrueck (DE); Waldemar Merling, Diepholz (DE); Henning Wöhl-Bruhn, Cremlingen (DE); Andreas Löhner, Vechelde (DE); Bernhard Bley, Hannover (DE); Norbert Pelz, Tappenbeck (DE); Oleg Semke, Gifhorn (DE)

(73) Assignee: ZF Friedrichshafen AG, Friedrichshafen (DE)

(21) Appl. No.: 16/063,969

(22) PCT Filed: Dec. 8, 2016
(86) PCT No.: PCT/EP2016/080191

§ 371 Date: Jun. 19, 2018

(30) Foreign Application Priority Data
Dec. 22, 2015 (DE) 10 2015 016 689.1

(51) Int. Cl. F16H 63/34; F16H 59/10; F16H 63/48

(52) U.S. Cl. CPC F16H 63/3466; F16H 63/48; F16H 59/10

(57) ABSTRACT

The invention relates to a shifting selection and parking lock system for a motor vehicle including a shifting selection device for engaging and disengaging transmission gears and/or for selecting at least one driving program, and a parking lock device for implementing a transmission parking lock mode. The shifting selection device has at least one gearshift lever unit with at least one gearshift lever. The parking lock device has at least one mechanical locking device and at least one electromechanical actuator that actuates the mechanical locking device. The gearshift lever unit and the electromechanical actuator are disposed in a common housing or the actuator is disposed in a separate housing and the gearshift lever unit is disposed directly on the separate housing of the actuator. The housing can be disposed in the region of the central console of the motor vehicle and/or integrated therein.

### BACKGROUND

The invention relates to a shifting selection and parking lock system for a motor vehicle according to the features in the preamble of claim 1.

In motor vehicles, an automated disengagement and engagement of the parking lock for the transmission of the motor vehicle is required in particular for driving assistance systems for, e.g. “intelligent parking assistance (IPA)” or for a “fully automatic parking and exiting (PILO-Park).” Various systems are known from the prior art for this. First, there are transmissions, i.e. motor vehicle transmissions, that have an integrated automatic parking lock, in particular those transmissions developed recently, in particular such automatic transmissions. The older transmissions known in the prior art, however, have an external parking lock actuator, in particular, which is disposed and/or provided on the exterior of the transmission housing. In this case, an electric parking lock device is then provided for implementing a transmission parking lock mode, which has a mechanical locking device, wherein the mechanical locking device is actuated via an electromechanical actuator. The electromechanical actuator is then actively connected directly to the parking lock shaft, or is actively coupled indirectly to the locking device via a cable pull or a rod. The first alternative specified above, specifically a transmission with an integrated automatic parking lock, must first be structurally conceived accordingly during the development of the transmission. A retroactive implementation of an automatic parking lock in existing transmissions basically requires a “complete redevelopment” of the respective transmission, because with the second alternatives specified above, thus with an external parking lock actuator provided on a transmission, the electromechanical actuator then requires activation electronics that must be integrated in the transmission electronics, wherein this means that for existing motor vehicle transmissions, these activation electronics must be “implemented” accordingly, such that basically the control device, or the transmission control device, and therefore the “transmission” itself, must be overhauled.

DE 10 2009 028 858 A1 thus describes a shifting selection and parking lock system for a motor vehicle that has an electric parking lock device for a motor vehicle transmission. The parking lock device has a mechanical locking device, which is actuated via an electromechanical actuator. Furthermore, a control and/or regulating unit for controlling and/or regulating the electromechanical actuator is provided. The actuator and the control and/or regulating unit is formed here as an assembly that can be mounted collectively on the vehicle transmission, in particular the transmission housing. The connections and/or circuitry wiring to the internal power supply and/or to corresponding actuation buttons provided in the vehicle must then be laid and/or disposed in part through the engine compartment, and in part through the dashboard, to the central console.

A shifting selection and parking lock system for a motor vehicle is described in U.S. Pat. No. 2015/0176709 A1 that has a shifting selection device for engaging and disengaging transmission gears, specifically at least one shifting selection unit with a gearshift lever, and a parking lock device. The parking lock device has a mechanical locking device and an electromechanical actuator disposed in the region of the transmission, wherein the electromechanical actuator is actively connected to the locking device by a cable pull. The signals of the shifting selection device and/or existing actuation buttons are processed via a control unit, also using an evaluation unit, such that then, depending on certain conditions, the locking device, or the electromechanical actuator, respectively, is activated accordingly, in order to activate or deactivate the parking lock, thus implementing the transmission parking lock mode. The electromechanical actuator is substantially disposed in the engine compartment, and the shifting selection device is substantially disposed in the interior of the vehicle, wherein the connections, in particular the cables, are laid between the engine compartment, vehicle interior and control device, or these must be coupled accordingly.

Lastly, a shifting selection and parking lock system for a motor vehicle is known from U.S. Pat. No. 8,437,930 B2, on which the invention is based, which has a shifting selection device for engaging and disengaging transmission gears and/or for selecting at least one driving program, wherein an electric parking lock device for implementing a transmission parking lock mode is also provided, in particular for activating or deactivating a locking device provided in the region of the transmission. The shifting selection device has a gearshift lever unit with a gearshift lever and a corresponding first separate housing. The parking lock device has an electromechanical actuator. The gearshift lever unit and the electromechanical actuator are disposed adjacent to one another, in particular next to one another. The electromechanical actuator actuates the mechanical locking device provided on the exterior of the transmission housing, and is actively coupled thereto, in particular via a cable pull.

Substantially common to all of the shifting selection and parking lock systems known from the prior art is that their placement and/or structure, in particular with locking devices disposed on the exterior of the transmission housing, which must be actuated via an electromechanical actuator, are very complex and very expensive. In particular, the arrangement and wiring of the electromechanical actuator in the engine compartment, or its circuitry connection to the control unit and/or the gearshift lever unit, is problematic, complex and expensive. Even with the generic prior art, serving as the basis for the invention (U.S. Pat. No. 8,437,930 B2), where the gearshift lever unit is adjacent to the electromechanical actuator, this construction is very complex, and can only be integrated in the vehicle interior of a motor vehicle with difficulty. Lastly, the noise in the passenger compartment is increased when the actuator is actuated due to the placement of the actuator. The shifting selection and parking lock systems known from the prior art are therefore not yet optimal in terms of their designs.

### SUMMARY

The invention therefore addresses the problem of designing and developing the shifting selection and parking lock system specified in the introduction, serving as the basis of the invention, such that the circuitry wiring, or coupling of the components is simplified, the associated costs are reduced, and in particular, a simple installation is ensured, and disruptive noises are eliminated.

This problem is first solved for the shifting selection and parking lock system with the features of claim 1.

First, the gearshift lever unit and the electromechanical actuator are disposed and/or provided in a common housing (first alternative) wherein the common housing is designed and/or constructed such that the common housing can be disposed in the region of the central console of the motor vehicle and/or integrated therein.

It is also conceivable that the actuator is disposed in a separate housing, and the gearshift lever unit is disposed directly on the separate housing of the actuator (second alternative), wherein the separate housing is designed and/or constructed such that the separate housing can be disposed in the region of the central console of the motor vehicle and/or integrated therein.

The installation is thus simplified, because substantially in a single installation step, the corresponding common housing with the gearshift lever unit and the electromechanical actuator, or the housing (a separate housing for the actuator, with a gearshift lever unit disposed on the exterior of the housing of the actuator) can be disposed on the central console of the motor vehicle, or integrated therein, in particular in that corresponding latching and/or snap-in connections are provided there. Because the central console is formed in the interior of the motor vehicle, the wiring, or the circuitry coupling of the components is substantially simplified, in particular the protection thereof against dirt, water/moisture, and/or corrosion, is simplified accordingly, or the costs for the corresponding protective measures are reduced accordingly. Moreover, the background noise in the interior of the vehicle is reduced, because the electromechanical actuator is either disposed, together with the gearshift lever unit, in a common housing (fist alternative), or in its own separate housing (second alternative).

The electromechanical actuator—when the housing is disposed in the region of the central console—is substantially disposed beneath the gearshift lever unit, wherein the actuator is actively connected to the locking device via a cable pull. As a result, the positioning of the cable pull, in particular through the tunnel system in the central console from the actuator to the locking device is simplified.

An evaluation unit is provided for detecting the position of the gearshift lever, for detecting the setting of the actuator, for activating the actuator and/or for communication with an electronic control unit and/or with a parking lock actuation switch of the motor vehicle, or the evaluation unit is electrically or electronically connected to the components specified in part above. The components necessary here for the connection, such as wiring, in particular CAN busses, communication and/or electrical system lines, can be shorter, because these can be connected over a short path from the central console to the respective components.

The evaluation unit is provided and/or disposed in the region of the gearshift lever unit, or integrated therein in the preferred embodiment. In this manner, the corresponding wiring can likewise be shorted, because in particular, the gearshift lever and its position must be detected on a continuous basis, and corresponding sensor signals must be sent to a control device and/or an evaluation unit.

It is also conceivable that the evaluation unit is provided and/or disposed in the region of the actuator, or is integrated therein. Such an arrangement/configuration is also conceivable, but then is dependent on the specific design of the shifting selection and parking lock system.

The gearshift lever unit and the actuator are connected in terms of circuitry via at least one first line for transmitting the activation signals to the control for the actuator, and via at least one second line for transmitting the sensor signals from the actuator to the gearshift lever unit. Because the gearshift lever unit and the actuator are disposed adjacent to one another in a common housing (first alternative) in preferred embodiments, the wiring for transmitting the control signals, or the signal lines, can be very short, because the two aforementioned components are located in a common housing, and no additional protective devices or protective elements are necessary for shielding against humidity, moisture and/or dirt, i.e. no rubber seals, O-rings and/or special closures are necessary, which contribute to the costs.

The common housing (first alternative) also has an electrical system port for connecting to the electrical system of the motor vehicle and/or an electronic and/or electrical communication port, in particular a CAN bus port for connecting to the control device and/or the electronics of the motor vehicle. As a result, the common housing can also be integrated in a simple manner in the central console of the motor vehicle, or two other preferred embodiments for connecting the components to the electrical system or to the control device of the motor vehicle are provided, specifically:

In the preferred embodiment, the electrical system port and/or the communication port of the common housing is connected to the gearshift lever unit. It is also conceivable, alternatively, that the electrical system port or the communication port is connected to the actuator in a circuit. With both of the aforementioned alternatives, it is advantageous that the wiring/connection of the substantial components, thus the gearshift lever unit and the actuator implemented in this manner with regard to supplying the respective components with a power supply, is simplified accordingly.

In the second alternative described above, thus when the gearshift lever unit is disposed directly on the separate housing of the actuator, or is connected thereto, the separate housing of the actuator and/or the gearshift lever then has an electrical system port for connecting to the electrical system of the motor vehicle and/or an electronic and/or electric communication port, in particular a CAN bus port for connecting to the control device and/or the electronics of the motor vehicle. As a result, the separate housing of the actuator with the gearshift lever disposed on the exterior can also be integrated in a simple manner in the central console of the motor vehicle. In the very preferred embodiment of the second alternative, when the actuator is provided in a separate housing, the gearshift lever unit also has an electrical system port as well as the electronic and/or electric communication port, in particular the CAN bus port. In another alternative design, the separate housing of the actuator also has an electrical system port.

Lastly, the gearshift lever unit and/or the actuator can be activated wirelessly, via a remote control, such that in particular the automatic parking and exiting (IPA or PILO-Park) can be implemented with the shifting selection and parking lock system described herein.

Ultimately, the shifting selection device is coupled to the electromechanical actuator in the respective embodiments of the shifting selection and parking lock system according to the invention, such that it is no longer absolutely necessary to equip the actuator with its own electronics, such that by interconnecting the shifting selection device and the parking lock device in the manner described above, thus with the gearshift lever unit and the actuator in a common housing (first alternative) or through the direct positioning of the gearshift lever unit on a separate housing of the actuator (second alternative), and in particular through the optimized coupling of the components in terms of circuitry, the advantages specified above are obtained, in particular, the gearshift lever unit and the actuator can also be activated via a common evaluation unit and/or a common control unit. This only requires a software for both systems, in particular, by means of which corresponding synergies are ensured for the overall system.

As a result, the disadvantages specified in the introduction are eliminated, and corresponding advantages are obtained.

There are thus numerous possibilities for designing and developing the shifting selection and parking lock system according to the invention for a motor vehicle in an advantageous manner. In this regard, reference can first be made to the claims subordinate to claim 1. Numerous designs of the invention are explained in greater detail below based on the drawings and the associated descriptions thereof. Therein:

### BRIEF DESCRIPTION OF THE DRAWINGS

FIG. 1 shows a first preferred embodiment of a shifting selection and parking lock system for a motor vehicle in a schematic illustration with the substantial components and the common housing (first alternative),

FIG. 2 shows a second embodiment of a shifting selection and parking lock system for a motor vehicle in a schematic illustration with the substantial components and the common housing (first alternative),

FIG. 3 shows a third embodiment of a shifting selection and parking lock system for a motor vehicle in a schematic illustration with the substantial components and the separate housing for the actuator (second alternative), and

FIG. 4 shows a fourth embodiment of a shifting selection and parking lock system for a motor vehicle in a schematic illustration with the substantial components and the separate housing for the actuator (second alternative).

### DETAILED DESCRIPTION

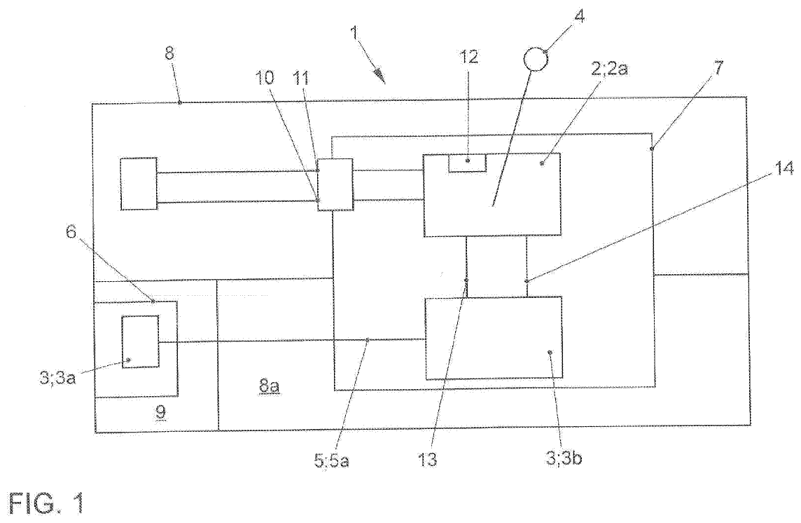

FIGS. 1 to 4 show—in a simplified schematic illustration—a shifting lever and parking lock system 1 for a motor vehicle, not shown in detail. FIGS. 1 to 4 show the substantial components relevant here in a schematic illustration, comprising, in general, the following:

First, at least one shifting selection device 2 is provided for engaging or disengaging transmission gears and/or for selecting at least one driving program of the motor vehicle. Furthermore, at least one, in particular an electrically actuatable, parking lock device 3 is provided for implementing a transmission parking lock mode. The shifting selection device 2 has at least one gearshift lever unit 2a, which has at least one gearshift lever 4. In particular, the gearshift lever 4 is supported and/or disposed at one end inside the gearshift lever unit 2a accordingly. The parking lock device 3 has at least one mechanical locking device 3a and at least one actuator 3b that actuates the mechanical locking device 3a. The mechanical locking device 3a is disposed in particular on a housing of a transmission 6, indicated schematically herein, wherein the electromechanical actuator 3b is actively coupled to the locking device 3a, substantially via a coupling element 5, in particular a cable pull 5a.

As FIGS. 1 to 4 show, the electromechanical actuator 3b is disposed and/or provided lying substantially adjacent to and/or substantially next to the gearshift lever unit 2a. These components are therefore substantially disposed adjacent to one another in the broader sense.

The parking lock device 3 serves to implement, thus to activate or deactivate, a parking lock, or a transmission parking lock mode, respectively, for the (motor vehicle) transmission 6, indicated schematically here, wherein the locking device 3a is coupled to the actuator 3b with the coupling element 5, or the cable pull 5a, such that the parking lock can be activated or deactivated in the transmission, or the transmission parking lock mode can be activated or deactivated, respectively.

The disadvantages specified above are thus eliminated, in that the gearshift lever unit 2a and the electromechanical actuator 3 are disposed and/or provided in a common housing 7 (first alternative), wherein the housing 7 is designed such that it can be disposed in the region of the central console 8 of the motor vehicle and/or integrated therein.

The aforementioned disadvantages are likewise eliminated in that the actuator 3b is disposed in a separate housing 7a, and the gearshift lever unit 2a is disposed directly on the separate housing 7a of the actuator 3b (second alternative), wherein the housing 7a is designed such that it can be disposed in the region of the central console 8 of the motor vehicle and/or integrated therein.

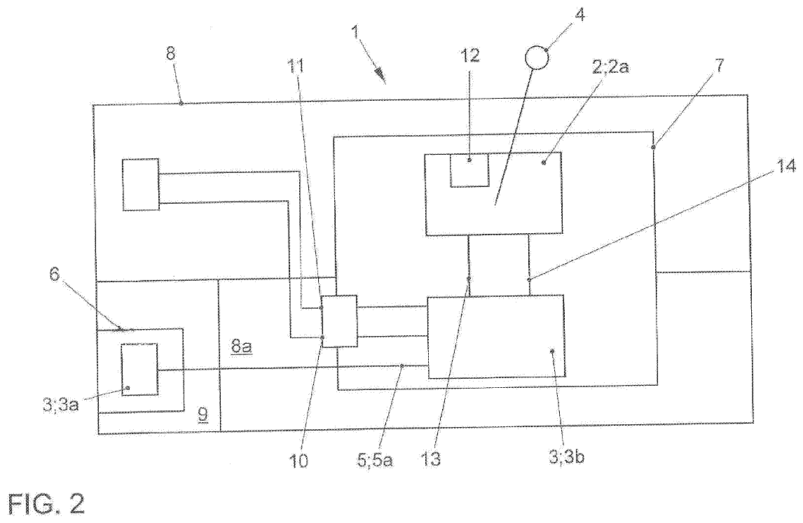

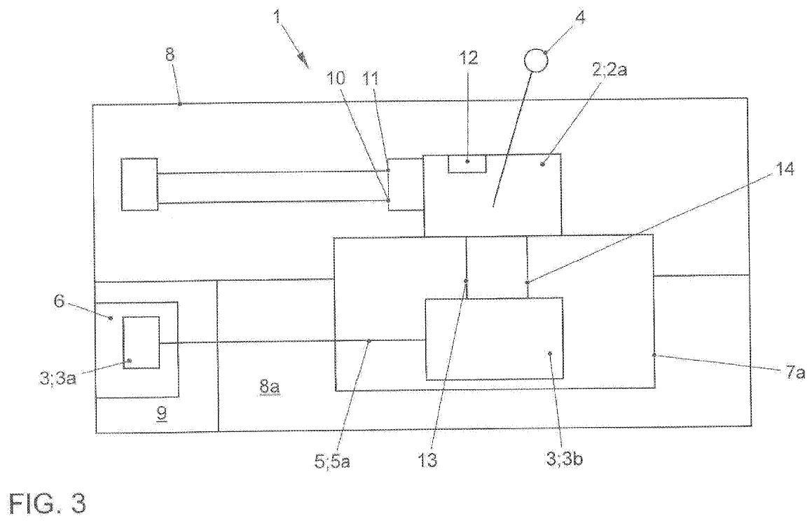

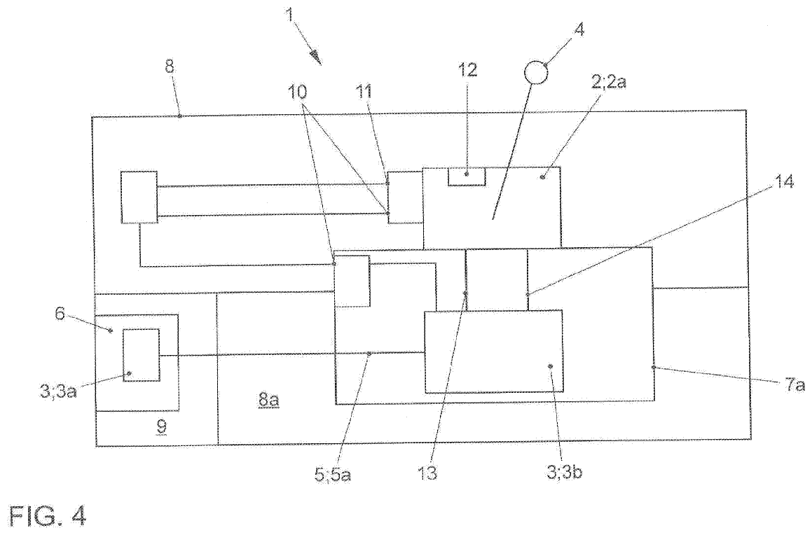

FIGS. 1 and 2 show, in a schematic illustration, the first alternative specified above, specifically the common housing 7, wherein FIGS. 3 and 4 show the aforementioned second alternative, specifically the separate housing 7a.

In further explanation, FIGS. 1 and 2 show, in a schematic illustration, the common housing 7 in which the gearshift lever unit 2a and the actuator 3b, in particular—when the housing 7 is disposed in the region of the central console—above one another, wherein here, the electromechanical actuator 3b is disposed beneath the gearshift lever unit 2a. The central console 8 can also be clearly seen here in a schematic depiction, which is provided in the interior of the vehicle, as well as the tunnel 8a, indicated schematically here, through the central console 8 and the engine compartment 9, which contains the (motor vehicle) transmission 6 and the locking device 3a indicated therein.

In FIGS. 3 and 4, identical components are indicated with identical reference symbols (as those in FIGS. 1 and 2). FIGS. 3 and 4 show, in a schematic illustration, the separate housing 7a, wherein the actuator 3b in the housing 7a and the gearshift lever unit 2a are connected directly to the separate housing 7a, or are disposed here, as can be seen in FIGS. 3 and 4. This separate housing 7a can also be disposed in the region of the central console 8. The central console 8, which is provided in the interior of the vehicle, and the tunnel 8a through the central console 8 and the engine compartment 9, containing the motor vehicle transmission 6 and the locking device 3a, can also be clearly seen in FIGS. 3 and 4, in the schematic depictions thereof.

When the gearshift lever unit 2a and the actuator 3b are disposed in a common housing 7 according to FIGS. 1 and 2, or when the separate housing 7a is disposed/formed according to FIGS. 3 and 4, various advantages are obtained, and in particular the wiring and/or form of certain plug-in connections is structurally simplified, such that the corresponding costs can be reduced. The common housing 7 or the separate housing 7a (cf. FIGS. 1 to 4) only requires an electrical system port 10 and/or a communication port. As a result of this design, the installation in the central console 8 is significantly simplified. In particular, the respective housing 7/7a can be inserted in the central console 8, and/or easily installed via plug-in connections or quickly snapped in place via snap-in connections.

An evaluation unit 12 is also provided for detecting the position of the gearshift lever 4, for detecting the setting of the actuator 3b, thus whether a parking lock or a transmission parking lock mode is activated or deactivated in the transmission, and/or for communication with an electronic control unit of the motor vehicle, not shown in detail here. Furthermore, the evaluation unit 12 is configured in particular such that it can be connected to a parking lock actuation switch, likewise not shown in detail here. In other words, the aforementioned components are at least in part connected electronically/via circuitry to the evaluation unit 12, as can be seen in part in FIGS. 1 to 4.

With the preferred embodiments according to FIGS. 1 to 4, the evaluation unit 12 is provided and/or disposed in the region of the gearshift lever unit 2a or integrated therein, as indicated schematically. It is also conceivable for the evaluation unit to be provided or disposed in the region of the actuator and/or integrated therein, but only in certain applications, because placement of the evaluation unit 12 in the region of the gearshift lever unit 2a is the preferred embodiment, because in this region in particular, an evaluation unit/control unit must be or is also already provided here for adjusting/controlling the gearshift lever 4.

As FIGS. 1 to 4 show, the gearshift lever 4 extends at least in part out of the common housing 7 in particular, or upward from the gearshift lever unit 2a, respectively.

As FIGS. 1 to 4 show, the gearshift lever unit 2a and the actuator 3b are interconnected in a circuitry via at least one first line 13 for transmitting the activation signals for controlling the actuator 3b and via at least one second line 14 for transmitting the sensor signals from the actuator 3b to the gearshift lever unit 2a. These conductive paths can be shortened, because the gearshift lever unit 2a and the actuator 3b are adjacent to one another, disposed in particular in a common housing 7, or the gearshift lever unit 2a is disposed directly on the separate housing 7a of the actuator 3b.

As already mentioned, the common housing 7 has an electrical system port 10 in the two preferred embodiments (cf. FIGS. 1 and 2) for connection with the electrical system of the motor vehicle and/or an electronic and/or electric communication port 11, in particular a CAN bus for connecting to the control device and/or the electronics of the motor vehicle. As a result of this connection, a simple installation of the housing 7 inside the central console 8 is ensured or enabled.

In the embodiment shown in FIG. 1, the electrical system port 10 and/or the communication port 11 is connected through a circuit to the gearshift lever unit 2a. In the embodiment shown in FIG. 2, the electrical system port 10 and/or the communication port 11 is connected through a circuit to the actuator 3b.

In the embodiment shown in FIG. 3, the gearshift lever unit 2a has an electrical system port 10 and a communication port 11. The communication port 11 configured in particular as a CAN bus for connecting to the control device and/or the electronics of the motor vehicle. In contrast, FIG. 4 shows the separate housing 7a can also have an electrical system port 10.

Lastly, the gearshift lever unit 2a and/or the actuator 3b can be activated wirelessly via a remote control.

As a result of the configuration or design of the gearshift lever unit 2a and the actuator 3b described above, in particular in a common housing 7, the evaluation unit 12 is also substantially disposed in the vehicle interior, or well protected against moisture, humidity and dirt therein. The wiring, in particular for an electrical system cable, a communication cable, and/or signal lines, is extremely simplified. Addition elements, or a large number thereof, for insulating and/or protecting the wiring, such as gaskets or seals, etc. which would otherwise be necessary in the engine compartment, are eliminated, or the number thereof is reduced accordingly. Protection against high temperatures normally not occurring in the interior, is likewise obtained.

As a result, a shifting selection and parking lock system 1 can therefore also be implemented in existing transmissions from the prior art, wherein this shifting selection and parking lock system 1 is also suitable or designed for monostable shift actuation designs of gearshift levers 4.

### REFERENCE SYMBOLS

1 shifting selection and parking lock system

2 shifting selection device

2a gearshift lever unit

3 parking lock device

3a locking device

3b actuator

4 gearshift lever

5 coupling element

5a pull cable

6 transmission (motor vehicle transmission)

7 common housing

7a separate housing for the actuator

8 central console

8a tunnel

9 engine compartment

10 electrical system port

11 communication port

12 evaluation unit

13 first line

14 second line

1. A shifting selection and parking lock system for a motor vehicle, the shifting selection and parking lock system including at least one shifting selection device for engaging and disengaging transmission gears and for selecting at least one driving program and at least one parking lock device for implementing a transmission parking lock mode, wherein the shifting selection device has at least one gearshift lever unit with at least one gearshift lever, wherein the parking lock device has least one a mechanical locking device and an electromechanical actuator that actuates the mechanical locking device, and wherein the electromechanical actuator lies substantially adjacent to the gearshift lever unit wherein the gearshift lever unit and the electromechanical actuator are disposed in a common housing or the actuator is disposed in a separate housing and the gearshift lever unit is disposed directly on the separate housing, the common housing or the separate housing disposed in a region of a central console of the motor vehicle.

2. The shifting selection and parking lock system according to claim 1, wherein, with the common housing or the separate housing disposed in the region of the central console, the electromechanical actuator is disposed substantially beneath the gearshift lever unit and actively connected to the locking device via a pull cable.

3. The shifting selection and parking lock system according to claim 1, further comprising an evaluation unit for at least one of the following: detecting a position of the gearshift lever, detecting a setting of the electromechanical actuator, activating the electromechanical actuator, and communicating with an electronic control unit or a parking lock actuation switch of the motor vehicle.

4. The shifting selection and parking lock system according to claim 1, further comprising an evaluation unit disposed in a region of the gearshift lever unit.

5. The shifting selection and parking lock system according to claim 1, further comprising an evaluation unit disposed in a region of the electromechanical actuator.

6. The shifting selection and parking lock system according to claim 1, wherein the electromechanical actuator is connected via circuitry to the gearshift lever unit via a first line for transmitting activation signals for controlling the electromechanical actuator and via a second line for transmitting one or more sensor signals from the electromechanical actuator to the gearshift lever unit.

7. The shifting selection and parking lock system according to claim 1, wherein one of the common housing, the separate housing, and the gearshift lever unit comprises at least one of an electrical system port for connection with an electrical system of the motor vehicle and a communication port for connection to an electronic control device of the motor vehicle.

8. The shifting selection and parking lock system according to claim 7, wherein at least one of the electrical system port and the communication port is connected via circuitry to the gearshift lever unit.

9. The shifting selection and parking lock system according to claim 7, wherein at least one of the electrical system port and the communication port is connected to the electromechanical actuator via circuitry.

10. The shifting selection and parking lock system according to claim 1, wherein at least one of the gearshift lever unit and the electromechanical actuator is activated wirelessly via a remote control.

11. A shifting selection and parking lock system for a motor vehicle, comprising:
a shifting selection device for engaging transmission gears, the shifting selection device including a gearshift lever unit with a gearshift lever; and
a parking lock device for implementing a transmission parking lock mode, the parking lock device including a mechanical locking device and an actuator that actuates the mechanical locking device, wherein the gearshift lever unit and the actuator are disposed in a common housing or the actuator is disposed in a separate housing and the gearshift lever unit is disposed on the separate housing.

12. The shifting selection and parking lock system according to claim 11, wherein the common housing or the separate housing is disposed in a region of a central console of the motor vehicle.

13. The shifting selection and parking lock system according to claim 12, wherein the actuator is disposed substantially beneath the gearshift lever unit and actively connected to the locking device via a pull cable.

14. The shifting selection and parking lock system according to claim 11, further comprising an evaluation unit for at least one of the following: detecting a position of the gearshift lever, detecting a setting of the actuator, activating the actuator, and communicating with an electronic control unit or a parking lock actuation switch of the motor vehicle.

15. The shifting selection and parking lock system according to claim 11, further comprising an evaluation unit integrated with the gearshift lever unit.

16. The shifting selection and parking lock system according to claim 11, further comprising an evaluation unit integrated with the actuator.

17. The shifting selection and parking lock system according to claim 11, wherein the actuator is connected to the gearshift lever unit via a first line for transmitting activation signals from the gearshift lever unit for controlling the actuator and via a second line for transmitting one or more sensor signals from the actuator to the gearshift lever unit.

18. The shifting selection and parking lock system according to claim 11, wherein one of the common housing, the separate housing, and the gearshift lever unit comprises at least one of an electrical system port for connection with an electrical system of the motor vehicle and a communication port for connection to an electronic control device of the motor vehicle.

19. The shifting selection and parking lock system according to claim 18, wherein at least one of the electrical system port and the communication port is connected via circuitry to the gearshift lever unit or the actuator via circuitry.

20. The shifting selection and parking lock system according to claim 11, further comprising a remote control configured to wirelessly activate at least one of the gearshift lever unit and the actuator.
